(19) United States
(12) Patent Application Publication
(10) Pub. No.: US 2009/0109242 A1
(43) Pub. Date: Apr. 30, 2009

(54) DISPLAY APPARATUS

(75) Inventors: Hsiao-Chang KUO, Jhubei City (TW); Chieh-Yuan CHAO, Jhubei City (TW)

Correspondence Address: Muncy, Geissler, Olds & Lowe, PLLC, P.O. BOX 1364, FAIRFAX, VA, 22038-1364, US

(73) Assignee: Sitronix Technology Corp.

(21) Appl. No.: 12/053,683

(22) Filed: Mar. 24, 2008

(30) Foreign Application Priority Data
Oct. 24, 2007 (TW) 96143355

(51) Int. Cl. G09G 5/00

(52) U.S. Cl. 345/659

(57) ABSTRACT

A display apparatus including a process module, a screen and an electric module is provided. The process module determines the display mode of an image according to the format of the image. The screen coupling the process module displays the image. The electric module coupling the screen and the process module adjusts the screen in the orientation in accordance with the display mode of the image. Thus, the display apparatus automatically adjusts the screen in the orientation in accordance with whether the display mode of an image is in the portrait mode or the landscape mode.

### RELATED APPLICATIONS

This application claims priority to Taiwan Application Serial Number 96143355, filed Oct. 24, 2007, which is herein incorporated by reference.

### BACKGROUND

1. Field of Invention

The present invention relates to a display apparatus. More particularly, the present invention relates to an apparatus that automatically adjusts a screen in a pre-specified orientation according to whether the image display mode is in a portrait mode or in a landscape mode.

2. Description of Related Art

Many of the latest digital products, including laptops, PDA, digital cameras, digital displays, mobile phones, digital picture frames etc, have screens.

However, images may be displayed in a portrait (vertical) or landscape (horizontal) orientation. Generally, most screens are set in a horizontal orientation. When a vertically oriented image is displayed on a horizontal screen, the image is either scaled down and appears smaller or only a part of the image is displayed on the screen.

For the foregoing reasons, there is a need for a display apparatus that automatically adjusts the screen orientation according to the orientation of the image being displayed. That is, if a vertical image is going to be displayed, the screen is automatically oriented in portrait mode (vertical) and if a horizontal screen is displayed, the screen is automatically oriented in landscape mode (horizontal).

### SUMMARY

It is therefore an objective of the present invention to provide a display apparatus that automatically adjusts the screen orientation in accordance with whether the image is in a portrait mode or in a landscape mode.

In accordance with an embodiment of the present invention, the display apparatus includes a process module, a screen and an electric module. The process module determines the display mode of an image according to a format of the image. The screen coupling the process module displays the image. The electric module coupling the screen and the process module sets the screen in the orientation according to the orientation of the image. Thus, the display apparatus i automatically adjusts the orientation of the screen in accordance with the orientation of the image, whether the image is in a portrait mode or in a landscape mode.

It is another objective of the present invention to provide a display apparatus that detects changes in the orientation thereof, and automatically adjusts the screen in the correct orientation.

In accordance with another embodiment of the present invention, a display apparatus includes a process module, a screen, an orientation-sensing device and an electric module. The process module automatically determines the orientation of the display mode in accordance with the orientation of the image. The screen coupling the process module displays the image. The orientation-sensing device generates a sensing signal when the orientation of the display apparatus is changed. The electric module automatically sets the screen in the correct orientation in accordance with the sensing signal. Thus, a display apparatus detects changes of orientation in an image and automatically adjusts the screen in accordance with the image orientation.

It is to be understood that both the foregoing general description and the following detailed description are by examples, and are intended to provide further explanation of the invention as claimed.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 is a block diagram of a display apparatus according to an embodiment of the present invention;

FIG. 2A is a front view of a display apparatus according to an embodiment of the present invention; and

FIG. 2B is a front view of a display apparatus according to an embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

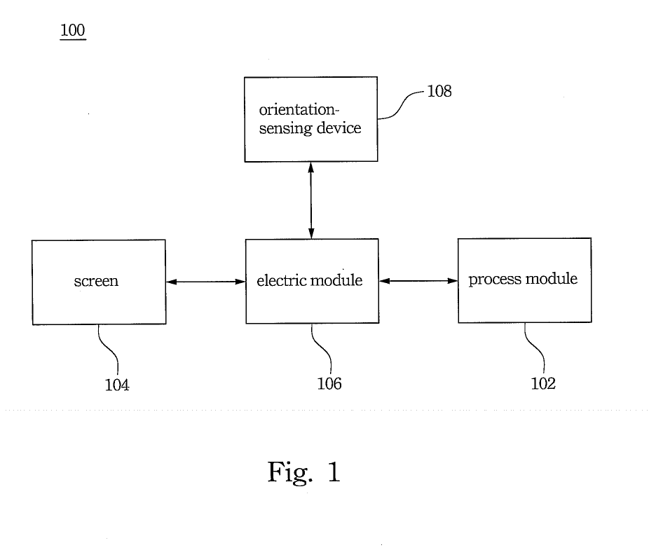

Please refer to FIG. 1. FIG. 1 is a block diagram of a display apparatus according to an embodiment of the present invention. The display apparatus 100 includes a process module 102, a screen 104, an electric module 106 and an orientation-sensing device 108. The electric module 106 is coupled with the screen 104, the process module 102 and the orientation-sensing device 108. Images are displayed on the screen 104. The process module 102 determines the orientation of the image. The electric module 106 adjusts the orientation of the screen 104 in accordance with the display mode. The orientation-sensing device 108 drives the electric module 106 to adjust the orientation of the screen 104 when the orientation of the display apparatus 100 is changed.

In an embodiment, the process module 102 determines whether the image is in a portrait mode or in a landscape mode, according to the format of the image, such as exchangeable image file format (EXIF). The portrait mode is a vertical orientation and the landscape mode is a horizontal orientation. For example, an image in the portrait mode has a width/height ratio of about 3:4 or about 9:16 whereas an image in the landscape mode has a width/height ratio of about 4:3 or about 16:9. The electric module 106 orientates the screen 104 in accordance with the orientation of the image, and the screen 104 displays the image. Additionally, the screen 104 may be set in a vertical orientation or in a horizontal orientation. If the screen 104 is set in a vertical orientation the width/height ratio of the screen 104 is about 3:4 or about 9:16; whereas if the screen 104 is set in a horizontal orientation the width/height ratio of the screen 104 is about 4:3 or about 16:9. The process module 102 drives the electric module 106 to adjust the screen 104 in a vertical orientation if t the image is in the portrait mode and the screen 104 is set in horizontal orientation, so that the screen 104 set in vertical orientation displays the image in the portrait mode. On the other hand, the process module 102 drives the electric module 106 to adjust the screen 104 in a horizontal orientation if the display mode of the image is the landscape mode and the screen 104 is set in vertical orientation, so that the screen 104 set in horizontal orientation displays the image with the landscape mode. Thus, the display apparatus 100 adjusts the screen 104 to be set in a vertical orientation or in horizontal orientation automatically, according to whether the image is in the portrait mode or the landscape mode, so that a user may see the image more easily.

In other embodiments, the display apparatus 100 may detect a change in the orientation of an image and may automatically adjust the orientation of screen 104 accordingly. If the orientation-sensing device 108 detects that the orientation of the display apparatus 100 is changed, and generates a sensing signal to drive the electric module 106 to adjusting the screen 104 to be set in the same orientation. For example, if the screen 104 is in the horizontal orientation to display an image in the landscape mode. When the display apparatus 100 is pivoted 30 degrees counterclockwise, the screen 104 is not set in the horizontal orientation. The orientation-sensing device 108 detects that the orientation of the display apparatus 100 has changed, and generates a sensing signal to drive the electric module 106 to pivot the screen 104 30 degrees clockwise. Thus, the screen 104 is set in a horizontal orientation to display the image in the landscape mode as usual.

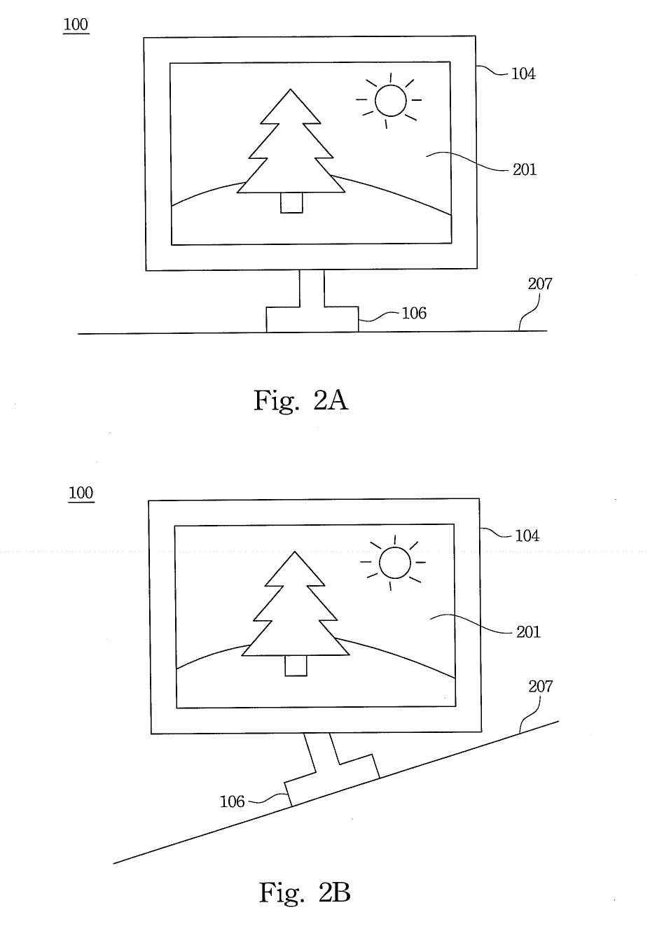

For a more complete understanding of the present invention, and the advantages thereof, please refer to FIG. 2A and FIG. 2B. FIG. 2A and FIG. 2B are front views of the display apparatus according to an embodiment of the present invention. In FIG. 2A, the display apparatus 100 includes the screen 104 and the electric module 106. The screen 104 is horizontal and displays a landscape mode image 201. One side of the electric module 106 is placed on a plane. In FIG. 2B, as the display apparatus 100 is pivoted at a counterclockwise angle, the screen 104 shifts from its horizontal orientation. The electric module 106 then pivots the screen 104 at an equivalent clockwise angle. Thus, the screen 104 remains horizontal orientation and displays a landscape mode image 201 as usual. Therefore the display apparatus 100 may detect changes in orientation thereof and may automatically adjust the screen 104 in the correct orientation. One of ordinary skill in the art will appreciate that the above examples are provided for illustrative purposes only to further explain applications of the present invention and are not meant to limit the present invention in any manner.

In embodiments, the display apparatus 100 may be a digital display or a digital picture frame. Furthermore, the screen 104 may be a liquid crystal display (LCD), a plasma display panel (PDP), a field emission display (FED), a cathode ray tube (CRT), and combinations thereof. In addition, the above-mentioned image may be a static image (ex: picture, photo) or a dynamic image (ex: video).

The above-mentioned process module 102 and the embodiments thereof may use software or a circuit. It will be readily understood by those skilled in the art that methods may be varied while remaining within the scope of the present invention.

In an embodiment, the electric module 106 includes an electric motor for pivoting the screen 104, which achieves an objective to adjust the screen 104 in orientation. In addition to the electric motor, other machine may also be used.

Accordingly, it should be appreciated by those skilled in the art. The display apparatus 100 not only may adjust the screen 104 in orientation according to whether a display mode of an image is a portrait mode or a landscape mode, but also may detect a change of an orientation thereof and may adjust the screen 104 to be set in orientation automatically, which achieves the objective of the present invention.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A display apparatus, comprising:
a process module for determining a display mode of an image according to a format of the image;
a screen coupling the process module for displaying the image; and
an electric module coupling the screen and the process module for adjusting the screen to be set in orientation according to the display mode of the image.

2. The display apparatus as claimed in claim 1, wherein the format is EXIF.

3. The display apparatus as claimed in claim 1, wherein the display mode is a portrait mode or a landscape mode.

4. The display apparatus as claimed in claim 3, wherein the electric module adjusts the screen to be set in vertical orientation when the display mode is in the portrait mode.

5. The display apparatus as claimed in claim 3, wherein the electric module adjusts the screen to be set in horizontal orientation when the display mode is in the landscape mode.

6. The display apparatus as claimed in claim 3, further comprising:
An orientation-sensing device generates a sensing signal when the orientation of the display apparatus is changed.

7. The display apparatus as claimed in claim 6, wherein the electric module coupling the orientation-sensing device adjusts the screen to be set in orientation according to the sensing signal.

8. The display apparatus as claimed in claim 7, wherein the electric module adjusts the screen to be set in vertical orientation when the display mode is the portrait mode.

9. The display apparatus as claimed in claim 7, wherein the electric module adjusts the screen to be set in horizontal orientation when the display mode is the landscape mode.

10. The display apparatus as claimed in claim 1, wherein the image is a static image or a dynamic image.

11. The display apparatus as claimed in claim 1, wherein the screen is a liquid crystal display (LCD), a plasma display panel (PDP), a field emission display (FED), a cathode ray tube (CRT), and combinations thereof.

12. The display apparatus as claimed in claim 1 is a digital photo frame.

13. A display apparatus, comprising:
a process module for determining a display mode of an image according to a format of the image;
a screen coupling the process module for displaying the image;
an orientation-sensing device for generating a sensing signal when an orientation of the display apparatus is changed; and
an electric module for adjusting the screen to be set in orientation according to the sensing signal.

14. The display apparatus as claimed in claim 13, wherein the format is EXIF.

15. The display apparatus as claimed in claim 13, wherein the display mode is in the portrait mode or the landscape mode.

16. The display apparatus as claimed in claim 15, wherein the electric module adjusts the screen to be set in vertical orientation when the display mode is the portrait mode.

17. The display apparatus as claimed in claim 15, wherein the electric module adjusts the screen to be set in horizontal orientation when the display mode is the landscape mode.

18. The display apparatus as claimed in claim 13, wherein the image is a static image or a dynamic image.

19. The display apparatus as claimed in claim 13, wherein the screen is a liquid crystal display (LCD), a plasma display panel (PDP), a field emission display (FED), a cathode ray tube (CRT), and combinations thereof.

20. The display apparatus as claimed in claim 1 is a digital photo frame.
